(19) United States
(12) Patent Application Publication
(10) Pub. No.: US 2008/0261603 A1
(43) Pub. Date: Oct. 23, 2008

(54) System for Optimizing Cellular Telephone Call Placement With Minimal User Overhead

(76) Inventors: Gil Sever, Rosh Haayin (IL); Noach Amit, Haifa (IL)

Correspondence Address: BROWDY AND NEIMARK, P.L.L.C.;624 NINTH STREET, NW, SUITE 300, WASHINGTON, DC, 20001-5303, US

(21) Appl. No.: 11/628,315

(22) PCT Filed: Jun. 2, 2005
(86) PCT No.: PCT/IL05/00581

§ 371 Date: Mar. 4, 2008

Related U.S. Application Data
(60) Provisional application No. 60/576,272, filed on Jun. 2, 2004.

(51) Int. Cl. H04Q 7/38; H04Q 7/22

(52) U.S. Cl. 455/445; 455/432.1

(57) ABSTRACT

A method and system for automatically placing calls made from a mobile telephone in an economical manner via calling card and call-back programs, with minimal user overhead. The system may be installed on an existing telephone by the user. To operate, the user initiates the placement of a call in the regular manner, as if the call were placed directly, and the system automatically places the call in the most economical way, such as via calling card or call-back program. The user can employ any dialing conveniences offered by the mobile telephone, including “speed dialing”, “phone book” dialing, or recent call dialing. All interaction with the calling card/call-back server is handled automatically; the user need not be aware that the call is being placed via a calling card or call-back program. Additional automatic features include automatic calling card recharging and selection of SIM for telephones supporting multiple SIM's.

### FIELD OF THE INVENTION

The present invention relates to mobile telephony, and, more particularly, to a method and system for placing mobile telephone calls in the most cost-effective manner with minimal user involvement in the placement process.

### BACKGROUND OF THE INVENTION

Mobile telephony is established on a widespread global basis, such that many mobile subscribers (also herein referred to as “users”) travel extensively with their mobile telephones, and typically expect to receive mobile service over a broad geographical range. Because subscribers roam from one supporting cellular network to another, they encounter extensive differences in telephone rates from one network to another, and would like to benefit from low-cost alternatives to direct dialing. In addition, subscribers also place long-distance telephone calls from within their own home networks, and would likewise appreciate low-cost alternatives to direct dialing of long-distance calls even when not roaming. In response to these opportunities, a number of subscriber calling options have been developed, by which subscribers can elect to place calls in a special manner to receive various benefits, such as lower cost of placing calls. One option centers around a “calling card” industry which offers mobile subscribers highly competitive international calling rates, well below the normal charges that would be assessed by the networks for making direct-dialed calls. Calling card plans not only benefit roamers who are calling from outside their home network, but may also be advantageous to mobile subscribers calling from within their home network. The term “mobile telephone” herein denotes any portable device used for mobile telephony, including, but not limited to: cellular telephones, “smart phones”, and cellular PDA's (“Personal Digital Appliances”). The term “direct-dialed” denotes outgoing calls routed directly via the network in which the mobile telephone is presently located.

In addition to calling-card schemes, there are other calling options which benefit mobile subscribers with lower costs. “Call-back” programs, for example, enable a subscriber to initiate a call, which is then completed by an inbound returned call to the subscriber (the “call-back”). The advantage is that technically, the subscriber's mobile telephone is not used to place the long-distance call—the subscriber is technically only receiving the call, which is placed by the call-back service at a lower cost than for a comparable direct-dialed call. Thus, the subscriber is not burdened with high call placement charges from the serving network—and in many areas, there is no charge to a subscriber for receiving calls. Cost savings through the use of a calling card or call-back solution are substantial, and can be up to 80% of the direct-dialed cost for comparable calls. The term “rate” is used to denote the cost for a given unit of time. Typically, it is not possible to predict the duration of a telephone call. Therefore, in cases where the cost of a telephone call depends on duration, it is typically not possible to predict the cost of the call. Thus, in place of cost comparisons, rate comparisons are most commonly used to select the most economical service or routing for a call.

In addition to calling cards and call-back programs, there are also new technological solutions which are becoming available. Voice Over IP (“VOIP”) service, for example, enables substantial reductions in the cost of global telephony.

Although calling cards and other solutions encourage competition and enable mobile subscribers to benefit from less-expensive long-distance service (which, as noted above, can be as low as 20% of the direct-dialed rate), these solutions are typically inconvenient and often difficult for the subscriber to use.

To appreciate this factor, first consider as a baseline the normal direct dialing within a mobile telephony network. The worst-case dialing of an international call might require the subscriber to dial 15 digits (a 3-digit access code+5 digits for country code and area code+a 7-digit phone number). Generally, however, this is not always necessary. The subscriber might have the telephone number stored in the mobile telephone's phone book or in the list of recent calls placed or received (a “call log”)—in which case only a few keystrokes are needed to bring up the number and place the call. Even better, if the stored telephone number is associated with a “speed dialing” key, the subscriber can direct-dial that number with a single button press.

In contrast to the ease and simplicity of direct dialing in the mobile telephony network, using a calling card involves far more effort by the subscriber. The mobile telephone's phone book, number recall, and speed dialing features typically cannot be used with calling cards. Thus, the subscriber must enter the calling card information manually. A sequence of events for using a typical international calling card is illustrated by the following scenario:
1. The subscriber needs a list of the calling-card provider's list of local access numbers, and must identify the correct number for his or her present locality (estimated time: approximately 30-60 seconds).
2. The subscriber must dial the access number for that particular locality (at least 8 keystrokes, plus an estimated 30-45 seconds connection and setup time).
3. The subscriber must enter his or her card number and Personal Identification Number (“PIN”) (typically at least 12 keystrokes plus an estimated 30 seconds total processing time).
4. The subscriber must dial the international destination number, international access code, country code, city code, and number (15 to 20 keystrokes, plus an estimated 30 seconds connection time).
Typical total keystrokes to place a call using a calling card: 35-40.
Typical total time to place call using a calling card: 2 minutes-2 minutes 45 seconds.

A similar scenario is observed when using a call-back scheme—as with a calling card, the mobile telephone's phone book, number recall, and speed dialing features typically cannot be used with call-back schemes:
1. The subscriber needs a list of the call-back provider's list of local access numbers, and must identify the correct number for his or her present locality (estimated time: approximately 30-60 seconds).
2. The subscriber must dial the access number for that particular locality (at least 8 keystrokes, plus an estimated 30-45 seconds connection and setup time).
3. After the call is terminated, the subscriber needs to wait for the call-back to the mobile telephone.
4. The subscriber must manually dial the destination number (up to 20 additional keystrokes, and 30 seconds connection time).
Total keystrokes to place a call using a call-back scheme: up to 35
Total time to place call using a call-back scheme: 50-90 seconds

In addition to the obstacles presented by the normal sequence, there are also the following complications:
In certain cases, it is necessary to pause and wait for tones or signals after keying in one code and before continuing to key in the following code. This further adds to the difficulty and burden of using the calling card or a call-back scheme.
The above scenarios illustrate the time and effort needed to place a calling card call or call-back call, assuming that the subscriber enters all the information correctly—if the subscriber enters an erroneous telephone number or international calling prefix, or enters an erroneous international calling prefix, or inadvertently omits a sequence or digit, the call cannot be completed and may be directed to a wrong telephone. If the subscriber enters an erroneous calling card number or code, it is generally necessary to repeat the entire procedure from the beginning.
Under certain circumstances, placing a direct call may be less expensive than using a calling card. The subscriber therefore has to determine if calling card use is justified. The choice may depend on the location from which the call is placed, the destination of the call, the day of the week, and the time-of-day. Furthermore, in addition to a calling card, the subscriber may also have access to a call-back program, in which case the subscriber may then be faced with the problem of determining which of the three alternatives (direct call placement, calling card, or call-back) provides the lowest calling rates.
Calling cards and call-back programs are in direct competition with mobile telephony service providers (network operators). By offering lower-cost telephone calls to subscribers, calling cards and call-back programs take long-distance business away from the service providers, who therefore have no incentive to facilitate use of calling cards and call-back programs by their subscribers. It is noted that there are several solutions in the prior art for making it easier to place calls using calling cards. For example: U.S. Pat. No. 5,509,056 to Ericsson, et al. (herein denoted as “Ericsson”); U.S. Pat. No. 5,845,205 to Alanara, et al. (herein denoted as “Alanara”); U.S. Pat. No. 5,991,384 to Wulkan (herein denoted as “Wulkan”); and U.S. Pat. No. 6,574,486 to Labban (herein denoted as “Labban”) involve schemes that typically require the support of the service providers. Ericsson and Alanara, for example, rely on features built in to cellular telephones. As noted above, it is to be expected that service providers (who typically market cellular telephones to their subscribers) would not feel any incentive to market equipment of this sort to their subscribers, for they would be providing their subscribers with apparatus that reduces their business revenue.

The net result of the above complications is that although calling cards and call-back programs provide significant cost savings over direct dialing, subscriber apparatus for facilitating the use of calling cards and call-back programs (such as mobile telephones furnished with calling card and call-back support) are not readily available. Consequently, subscribers are burdened with the task of manually handling the use of calling cards and call-back programs, and thus many subscribers prefer to pay the additional costs of direct dialing simply to avoid the aggravation associated with calling cards and call-back programs.

There is thus a widely recognized need for, and it would be highly advantageous to have, a method and system for using calling cards and call-back programs which do not impose additional subscriber overhead, which automatically select the most economical call placement, which place calls in an accurate manner with minimal chance of error, and which are readily available to mobile subscribers. These goals are attained by the present invention.

### SUMMARY OF THE INVENTION

The present invention is of a method and system for placing mobile telephone calls from any location in the world to any other location in the world, offering the benefits of:
automatic selection of subscriber calling option according to predetermined criteria, such as rate (the most economical rate), including but not limited to the use of calling cards, call-back programs, VOIP, GPRS (“General Packet Radio Service”), and data connections such as UMTS (“Universal Mobile Telecommunications System”); and
maximum accuracy, security, and subscriber convenience in placing calls, including but not limited to the use of phone-book dialing, call log dialing, recent number dialing, and speed dialing.

It is an objective of the present invention that the subscriber experience no added inconvenience when placing calls using any of the subscriber calling options as described above. Preferably, embodiments of the present invention will automatically manage financial accounts for the subscriber, including, but not limited to: calling card purchase and maintenance (such as “recharging”, which is renewing the calling time on a calling card); purchase of calling time; purchase of SIM, where possible; and purchase of other related services.

It is also an objective of the present invention that the operation, including the automatic choice of subscriber calling option, be pre-authorized by the subscriber but during operation be performed in a manner that is transparent to the subscriber; or, if subscriber input is required, that such input be done in a manner that is easiest for the subscriber.

It is furthermore an objective of the present invention that the capabilities afforded thereby be available to a subscriber for easy installation on the subscriber's existing mobile telephone, in a manner independent of the subscriber's service provider. In an embodiment of the present invention, the system is installed as a software package on “smart phones” (enhanced cellular telephones); in another embodiment of the present invention, the system is installed via the SIM toolkit, a Java SIM, or via other hardware devices. The present invention can be adapted to various mobile telephones, including, but not limited to: GSM, GPRS, UMTS, “smart phones”, and can be installed on mobile telephones using communications methods including, but not limited to: TDMA, CDMA, and WCDMA mobile telephones which accept software installation.

Embodiments of the present invention feature:
automatic selection of the best roaming network according to predetermined criteria, such as rate or service terms;
automatic identification and configuration of a Subscriber Identification Module (“SIM”) in cases where the mobile telephone contains a SIM; and automatic selection of a SIM according to predetermined criteria, in cases where the mobile telephone contains or accepts multiple SIM's; where appropriate, this would include advising the subscriber to use or reconfigure a specific SIM, or provide the mobile telephone with the anticipated results of a specific SIM that exists remotely, to enable the mobile telephone to provide the network with results equivalent to those that would have been accepted if the specific SIM was installed inside the mobile telephone.
local number dialing while roaming;
automatic purchase of calling cards, where this would result in added convenience and/or savings to the subscriber;
protecting calling cards against fraudulent use;
making calls using data communications, including but not limited to: General Packet Radio Service (“GPRS”), Universal Mobile Telecommunications System (“UMTS”); and Short Message Service (“SMS”).

It is noted that the act of “roaming” typically implies that the mobile telephone is located in a network other than the network of the subscriber's home service provider (in this case the subscriber is also referred to as a “foreign mobile subscriber”). The term “roaming”, however, may also denote a mobile telephone moving between Mobile Switching Centers (MSC's) in the subscriber's home network (in this case, the subscriber is also referred to as a “local mobile subscriber”).

A system according to embodiments of the present invention detects an attempt by the user to place a long-distance call, and then takes control of the mobile telephone to perform alternative operations which result in the placement of the call to the destination intended by the user, but in a manner that is less expensive, more secure, and more accurate. The system controls the mobile telephone to determine which networks are accessible, what country the networks are in, what SIM is loaded in the mobile telephone, and other relevant parameters, and uses this information to select the optimum way of placing the call according to pre defined characteristics.

Different embodiments of the present invention provide various capabilities, some or all of which may be offered to the subscriber. Certain features may be available only in specific locales; of the available features, the user may want to purchase only a subset.

Therefore, according to the present invention there is provided a method for placing an outgoing call from a mobile telephone to a destination having a destination telephone number entered on the mobile telephone by a user, the method including: (a) detecting a user attempt to place an outgoing call; (b) for an attempted outgoing call placement by a user, obtaining the destination telephone number dialed by the user; (c) determining whether the destination telephone number corresponds to a local outgoing call versus a long-distance outgoing call; (d) if the destination telephone number corresponds to a local outgoing call, returning to the detecting a user attempt; (e) if the destination telephone number corresponds to a long-distance outgoing call, aborting the user's attempted outgoing call placement; (f) determining an alternate routing for the outgoing call; (g) accessing a service providing the alternate routing; (h) sending the destination telephone number entered by the user; and (i) completing the placement of the outgoing call via the alternate routing.

In addition, according to the present invention there is provided a method for placing an outgoing call from a mobile telephone to a destination having a destination telephone number fed to the mobile telephone, the method including: (a) detecting a user attempt to place an outgoing call; (b) for an attempted outgoing call placement by a user, obtaining the destination telephone number dialed by the user; (c) determining a category corresponding to the destination telephone number; (d) if the destination telephone number corresponds to a first category of outgoing calls, placing the call through a default routing; (e) if the destination telephone number corresponds to a second category of outgoing calls, aborting the user's attempted outgoing call placement; (f) determining an alternate routing for the outgoing call; and (g) placing the outgoing call via the alternate routing.

### BRIEF DESCRIPTION OF THE DRAWINGS

The invention is herein described, by way of example only, with reference to the accompanying drawings, wherein:

FIG. 1 is a functional block diagram of a prior art mobile telephone with embedded capabilities for handling the placement of calls via calling cards.

FIG. 2 is a flowchart of a call placement method utilizing “AT” commands according to an embodiment of the present invention.

FIG. 3 is a functional block diagram of a mobile telephone with a call manager for handling the placement of calls via calling cards and call-back programs, according to a first embodiment of the present invention.

FIG. 4 is a functional block diagram of a mobile telephone with a call manager for handling the placement of calls via calling cards and call-back programs, according to a second embodiment of the present invention.

### DESCRIPTION OF THE PREFERRED EMBODIMENTS

The principles and operation of a system and method for placing mobile telephone calls according to the present invention may be understood with reference to the drawings and the accompanying description.

### Prior Art Calling Card Support and the Limitations Thereof

To appreciate the novel advances of the present invention for the support of calling cards and call-back programs, it is helpful to first review the prior art implementation

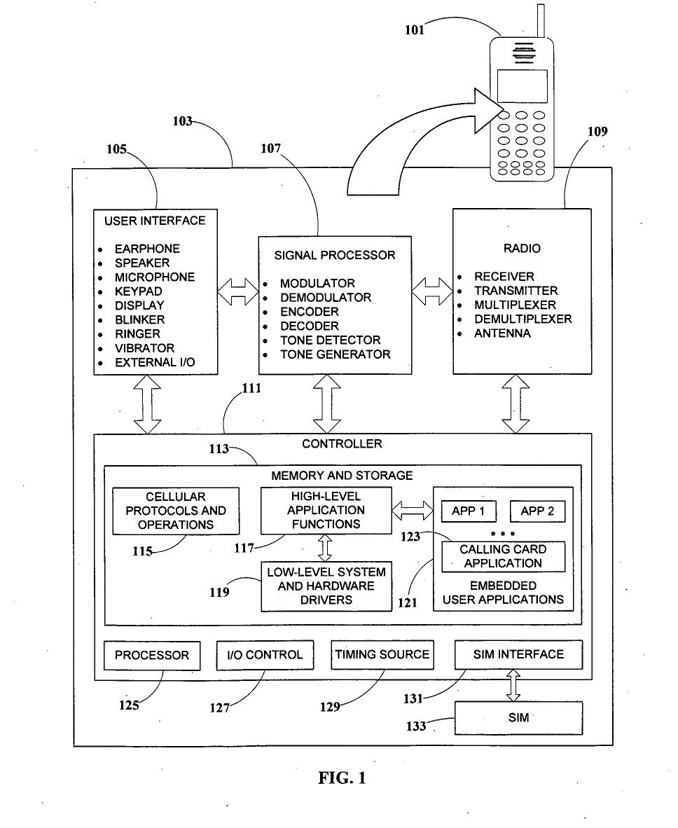

FIG. 1 is a functional block diagram of a prior art mobile telephone 101 with embedded capabilities for handling the placement of calls via calling cards, such as described in Ericsson and in Alanara. Internal functions block 103 includes a user interface 105, a signal processor 107, a radio 109, a controller 111, and an optional SIM 133. Controller 111 contains the following functional units: a processor 125, an I/O control 127, a timing source 129, an optional SIM interface 131 for optional SIM 133, and a memory and storage 113 for data and programmed operations. Memory and storage 113 contains a storage for cellular protocols and operations 115, a storage for high-level application functions 117, a storage for low-level system and hardware drivers 119, and a storage for embedded user applications 121. Within embedded user applications 121 are various application programs (“APP”), including a calling card application 123. The solutions disclosed by Ericsson and by Alanara, for example, are embedded user applications represented by calling card application 123.

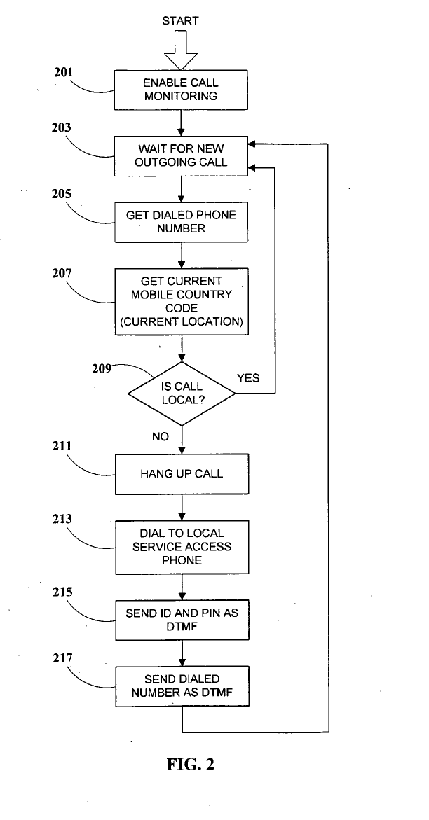

Specifically, in Alanara's FIG. 2 is a controller unit 36, which is described as follows “Controller 36 is a microprocessor containing an EEPROM that controls the entire cellular telephone” [U.S. Pat. No. 5,845,205 col. 4 lines 44-45]. Alanara's controller 36 corresponds to the present (prior art) controller 111 of the present FIG. 1, wherein calling card application 123 corresponds to code contained in Alanara's EEPROM as referenced above. Other correspondences between Alanara's FIG. 2 and the present FIG. 1 include: the unreferenced and unlabeled block surrounded by a dashed line to the left of controller 36 in Alanara's FIG. 2, which corresponds to the present user interface 105; and DSP 38, which corresponds to the present signal processor 107.

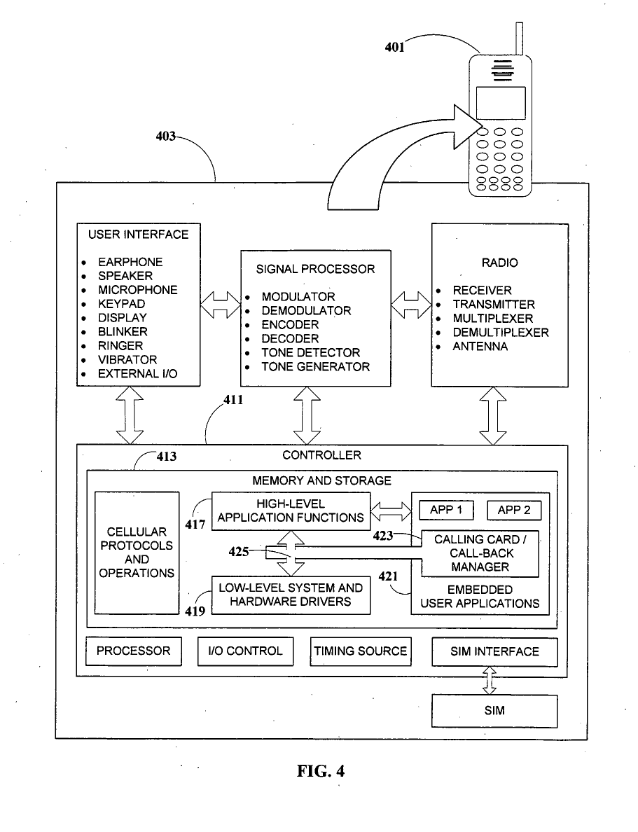

There is a similar correspondence between the present FIG. 1 and the block layout shown in Ericsson's FIG. 4A and FIG. 4B, which show a CPU 500, corresponding to the present controller 111. These figures of Ericsson also depict memory and storage elements 516 and 524, which collectively correspond to the present memory and storage 113. Ericsson's input control 518 and output control 520 correspond to the present I/O control 127. And Ericsson's cellular operations control 522 corresponds to the present cellular protocols and operations 115. In describing CPU 500 Ericsson states that: “a central processing unit (CPU) 500 may be an independent logic chip or representative of a function provided within a larger circuit” [U.S. Pat. No. 5,509,056 col. 12 lines 21-24]. Ericsson's CPU 500 performs the calling-card call management methods disclosed in Ericsson.

Ericsson provides for preprogrammed storage of calling card access numbers and verification data, for “ . . . easy programming of a predetermined sequence for completing calls through various calling card accounts” [U.S. Pat. No. 5,509,056 col. 2 lines 11-19], and thus has access to “speed dialing”, “last number recall”, and other conveniences for the user [U.S. Pat. No. 5,509,056 col. 12 lines 36-38]. As noted previously, however, mobile telephones with the capabilities such as disclosed in Ericsson and Alanara are not readily available to subscribers. Moreover, relying on functions that have been integrated into the mobile telephone operating system may restrict the subscriber from being able to take advantage of new calling services or expanded service opportunities.

Unfortunately, a limitation of the prior art solutions, as presented above, is that they must be incorporated into the mobile telephone at the time of manufacture or initial configuring of the mobile telephone, and cannot be retrofit into an existing mobile telephone by a subscriber. This limitation is due to the difficulty of altering the low-level operational characteristics of mobile telephones to incorporate automatic calling card and/or call-back program support, where no such support originally existed.

Without programming access to the mobile telephone's internal functions (in particular, the low-level system and hardware drivers 119 in FIG. 1), it is difficult, if not impossible, to alter the operational characteristics of a mobile telephone. Programming access requires detailed knowledge of the particular operating system firmware/software (in ROM/field-upgradeable flash memory) of the mobile telephone. Typically, programming access requires highly-detailed information, such as the code entry points of various internal functions. It is difficult enough to obtain this information for a single given mobile telephone model, and different mobile telephone models typically have different software configurations. Moreover, different mobile telephones of the same model often have different versions of the software. Furthermore, even if such information could be obtained, mobile telephones do not necessarily offer the capability of being reprogrammed at the operating system level.

### Method for Managing Calling Card and Call-Back Program Calls

According to the present invention, the above-discussed limitations of the prior art can be overcome by controlling operation of the mobile telephone at a higher level than is employed in the prior art solutions. Using a higher-level application eliminates the need to modify the mobile telephone's operating system, and does not require knowledge of code entry points. Most mobile telephones today offer the capability of being programmed for higher-level applications in order to accommodate new user features. Higher-level applications feature standardized data and command interfaces with the mobile telephone, a non-limiting example of which is the well-known AT (“Attention”) command set, such as is specified in the ETSI (“European Telecommunications Standards Institute”) Standard ETSI TS 100 916.

A method according to an embodiment of the present invention uses a higher-level application to automatically handle the placement of calls via calling cards and call-back programs, and is illustrated by the flowchart of FIG. 2. The present method is executed by a calling card/call-back manager (also denoted herein as a “call manager” for convenience), as is described in following sections.

The method illustrated in FIG. 2 is as follows: In a step 201, the monitoring of calls made with the mobile telephone is enabled. Thereafter, from this point forward, the method monitors the dialing performed by the user (the “subscriber”). A step 203 waits for the user to place a new outgoing call, in which the user enters a destination telephone number on the mobile telephone. It is noted that the user may enter the destination telephone number in various different ways, including, but not limited to: direct dialing, speed dialing, phone-book dialing, recent number dialing, and call log dialing. When the user attempts to place an outgoing call, a step 205 detects the user attempt to place an outgoing call and gets the dialed destination telephone number. An optional step 207 gets the current location of the mobile telephone in the form of the country code; step 207 is not always necessary in an embodiment of the present invention, there are cases where the outgoing telephone call is known to be an international call. The term “destination telephone number” herein denotes any symbol or sequence of symbols which specifies a destination for the outgoing call, including, but not limited to numbers, numeric character strings, alphabetic character strings, alphanumeric character strings, symbol character strings, punctuation character strings, and combinations thereof. The term “country code” herein denotes any codes which designate regions including, but not limited to: geographical regions, political regions, and mobile telephony network regions. The current “location” of a mobile telephone is typically expressed in terms of such regions, but may also be expressed in terms of a geographical coordinate system fixed with respect to the earth's surface, including, but not limited to: global longitude-latitude systems, grid systems, the Universal Transverse. Mercator (UTM) system; the World Geodetic System 1984 (WGS 84); and the U.S. National Grid (USNG) system. The verbs “dial”, “dialing”, “dialed”, “enter”, “entering”, “entered” and the like herein denote any action to enter data into a mobile telephone and to indicate choices thereto, including, but not limited to: destination telephone numbers, commands, selections, and responses. Furthermore, such actions associated with the verbs “dial”, “dialing”, “dialed”, “enter”, “entering”, “entered”, and the like herein include, but are not limited to: user key press on a keypad, or user activation of a button, control, or sensor of the mobile telephone; user voice activation; and automatic (programmatic) or machine entry of data into the mobile telephone, such as by a method or system according to the present invention.

At a decision point 209 it is determined whether or not the call the user is attempting to place is a local call or a long-distance call by examining the destination telephone number. If the call corresponds to a local destination, then there is no need to use alternate routing for the call, and the method resets by returning to step 203. The call is then completed by direct dialing.

The term “alternate routing” herein denotes an alternative means of placing the outgoing call, including but not limited to: direct dialing; calling card; and call-back program. Typically, an alternate routing is associated with a service access destination telephone number, and typically the service access destination telephone number is a local telephone number.

If, however, the call is not a local call but rather that the user is attempting to place a long-distance call, a step 211 hangs up the call. In effect, the automatic call manager which executes the present method aborts the direct-dialed call which the user has just attempted to place; the aborting occurs before the call is actually placed, so that there is no charge incurred by the user for the attempted direct-dialed call. In the process of the user's attempting to initiate the call, however, the mobile telephone will have captured the number which the user has dialed. This is the case regardless of how the user has placed the direct-dialed call. For example, the user may have dialed the complete number manually by pressing the keypad digits corresponding to the long distance number; the user may have utilized a “speed dialing” preset button; the user may have recalled a recently-dialed number; the user may have selected the number from the mobile telephone's “phone book” or call log; the user may have dialed the number via speech; or the user may have used some other shortcut to dial the number. In this manner, the present method is compatible with all the user conveniences offered by the mobile telephone. The term “long-distance call” herein denotes an outgoing call including, but not limited to: a call to a different network, a call to a region with a different country code, and a call not considered by the network to be a local call.

Continuing with the discussion of FIG. 2, after the user's attempted call placement has been aborted in step 211, a step 213 determines an alternate routing for the outgoing call, including, but not limited to: calling card, and call-back program. Step 213 also accesses the service which provides that alternate routing for the outgoing call. In an embodiment of the present invention, accessing the service is accomplished by dialing a service access number; in other embodiments of the present invention, accessing the service is accomplished by means including, but not limited to: opening a data session via GPRS, opening a data session via WiFi, and other means of opening a data session. In an embodiment of the present invention, the service access number is a local number. The call manager knows the dialing pattern and format for the calling card being used in the particular location from which the call is being made. In an embodiment of the present invention, the alternate routing is selected from multiple routings; in another embodiment of the present invention, the alternate routing is selected from multiple routings and is optimized according to predetermined criteria, such as most economical for the subscriber. The dialing of the local service access number and the entering of all pertinent data is done automatically by the call manager without any user intervention. The present method then completes the placement of the outgoing call via the alternate routing. In an embodiment of the present invention, a step 215 sends the subscriber ID and PIN (“Personal Identification Number”) as a DTMF (“Dual Tone Multi-Frequency”) sequence so that the calling card service or call-back program can properly identify and authorize placement of the call. In other embodiments of the present invention, only a single user code is necessary to be sent by step 215, for example, the user's PIN. Finally, a step 217 sends the long-distance number to be dialed. In an embodiment of the present invention, this is done as a DTMF sequence. In another embodiment of the present invention, step 217 also formats the destination telephone number according to the formatting rules in effect. For a call-back program, another embodiment of the present invention also receives the call-back. Once again, this is done automatically by the call manager without requiring additional input from the subscriber. Other necessary actions, such as pausing between transmitting sequences, waiting for special tones or signals from the local access server, or answering the call-back are also handled automatically by the call manager.

Because the present method is implemented as a higher-level application, the code for the method may be easily installed in existing mobile telephones.

In another embodiment of the present invention, the destination number of the outgoing call is fed to the mobile telephone, via means including dialing (as previously defined) and also including data feed means. Furthermore, the nature of the outgoing telephone call is assigned a category. Categories include, but are not limited to: direct-dial, local, long-distance; international long-distance; and data connection. The routing chosen for the call may depend on the category as well as other factors, such as cost and rate. The method for this embodiment is also illustrated by FIG. 2, wherein decision point 209 determines the category of the outgoing call and takes the appropriate action. For certain categories, flow returns to step 203—that is, the call is handled by the default operation, which, in an embodiment of the present invention, is direct-dial.

### Databases Included in the System

In order to perform the automatic selection functions as described herein, a system according to certain embodiments of the present invention uses one or more databases, including, but not limited to:
calling cards;
available calling cards;
conversion table from MCC (“Mobile Country Code”) to country name;
conversion table from prefix to country name;
mobile telephone service providers feature list;
mobile telephone rates;
roaming rates;
available SIM cards that the subscriber has or which can be provided by a remote center or simulated locally; and
calling patterns of calling cards from each country where operational.

The above data bases may have different versions for different users, and should be downloaded to the mobile telephone during system installation or update to reflect changes in rates, prefixes, etc.

In addition, databases may be customized with additional or alternate data. Non-limiting examples include:
details of a specific calling card used in a specific organization or enterprise for employees;
details of short calling codes used inside an organization or enterprise for fast connection; and
other specific details and parameters for a particular user or organization.

### Additional Call Manager Facilities

The present invention provides for a call manager to handle the placement of calls via calling cards and call-back programs. In addition to handling call placement, the call manager can automatically make other determinations and take further actions that are important in the economical placement of the call. Where there are multiple alternate routings for the call, predetermined criteria can be used to select the best alternate routing. In an embodiment of the present invention, rate is a predetermined criterion for this.

Such determinations include, but are not limited to:
identifying and ranking available networks (creating a list of the available networks arranged in order of preference according to predetermined criteria such as terms of service, rate, etc.), and selecting the best network (highly advantageous when roaming);
determining second- and third-best network, etc., for optimized selection when the best network is unavailable;
determining the country, cell, and estimated present location of the mobile telephone;
determining the most economical means of call placement based on the time, originating location, and destination of the call;
for multiple calling cards, determining the best card to use, according to predetermined criteria, such as rate (the most economical calling card to use);
identifying call routing with the minimum rate, based on relevant parameters such as present location, call destination, the available calling cards, time of day, and so forth;
identifying the installed SIM; and
identifying available SIM's in mobile telephones which support multiple SIM's, and recommending/selecting/configuring the best SIM to use.

In addition to making calling card and call-back calls, the call manager according to embodiments of the present invention is also capable of actions including, but not limited to:
encrypting sensitive calling card data, such as the calling card number, user PIN, etc., such as by using the destination number as one of the encryption parameters along with a random seed to prevent playback attacks; and
purchasing a calling card, or recharging an existing calling card, such as via the sending of an SMS with the purchase details, or via other data connection.

Moreover, the call manager is also able to automatically correct, modify, or adapt portions of a user's dialed entry that would give erroneous results. When roaming, for example, the user is liable to forget to prefix a call to a destination in his or her home network with the proper international prefix (this is particularly liable to happen when using “speed dialing”, a “phone book”, or other conveniences featured by the mobile telephone, because these features do not take roaming situations into account). According to an embodiment of the present invention, the call manager would automatically detect and correct this condition. Of course, the automated entry of local access numbers, user account information, and so forth, in itself also eliminates common sources of error.

Loading the System and/or Data Files into the Mobile Telephone

In embodiments of the present invention, the subscriber can download the system or data files into the mobile telephone. This can be done, for example, by sending the subscriber an SMS with the internet address of a download site. By connecting the mobile telephone with that download site (typically, mobile telephones feature Internet access), the system or data files can be downloaded to the mobile telephone via a cellular data channel.

In other embodiments of the present invention, the system and/or data files are loaded into a computer in order to be downloaded later to the mobile telephone via cable, Bluetooth link, infra-red link, WiFi link or other synchronization/communication channel from the computer to the mobile telephone.

This method allows downloading the system and/or data files to mobile telephones without a cellular data channel, but which can be synchronized by other means (e.g. wire, Bluetooth channel, infra-red channel etc.) to a computer. In this case the system or the data files are first downloaded to the computer from the Internet, and later passed to the mobile telephone via synchronization.

### Distributed System

In an embodiment of the present invention, a complete system comprises several blocks, including, but not limited to:
A software system installed in the mobile telephone, including via SIM installation, with components such as, but not limited to:
   application software; and
   data files with data and parameters organized in databases, lists, and other ways, that provide the application software the input required to make its decisions and perform its task of creating the cheapest, secured and accurate phone call.
Components located at a central site, featuring functions such as, but not limited to:
   description of the system, prices, and ways to subscribe to the service and to download the system to mobile telephones;
   a subscription mechanism;
   a facility for downloading the system directly to the mobile telephone through a data channel;
   a facility for downloading the system to a computer that then can transfer the system to the mobile telephone via cable, Bluetooth connection, infra-red connection, etc.
   a facility to exchange the IP address of mobile telephones operating behind a NAT (“Network Address Translation”) protocol which hides their addresses (e.g. mobile telephones that operate behind the gateway of a service provider), for the establishment of VOIP calls over data channels;
   authentication and billing functions; and
   support for mobile telephones with minimal systems requiring data files, calculations, etc., via a remote server.
Servers in various locations for selling interfacing to calling card re-sellers, featuring functions including, but not limited to:
   real-time interface to calling card vendors for purchase transactions;
   secured calling card verification for preventing calling card fraud in sales and use; and
   support for mobile telephones with minimal systems requiring data files, calculations, etc., via a remote server.

### Call Manager Location and Configuration

According to embodiments of the present invention, the call manager resides entirely on-board the mobile telephone; according to other embodiments of the present invention, the call manager comprises one or more remote components (not on-board the mobile telephone) in a central location or in several central locations, in order to reduce the CPU and memory requirements of the mobile telephone, to reduce the need for periodic updating of data files thereon, and also for simulating the reply of the mobile telephone to conform to that of a specific SIM. For embodiments which feature remote components, there is a data channel between the mobile telephone and the central site or sites; this connection, however, can be established when convenient, and need not interfere with the placing of any calls. As a non-limiting example, consider a subscriber roaming in a new country. For this subscriber, a data connection can be established to the center in order to obtain relevant information about the specific roaming area. After that, however, as long as the mobile telephone remains in the same roaming area, calls can be placed and handled entirely by the mobile telephone itself, without having to establish any further data connections.

The call manager may be configured differently within the mobile telephone, and integrated therein at different points, depending on the operating system used by the mobile telephone. Commonly-encountered operating systems include, but are not limited to: Symbian, Palm-OS, Windows Mobile, and Windows CE.

The following sections describe different embodiments according to the call manager's location and configuration.

### Call Manager Between Controller and Telephone Sub-Units

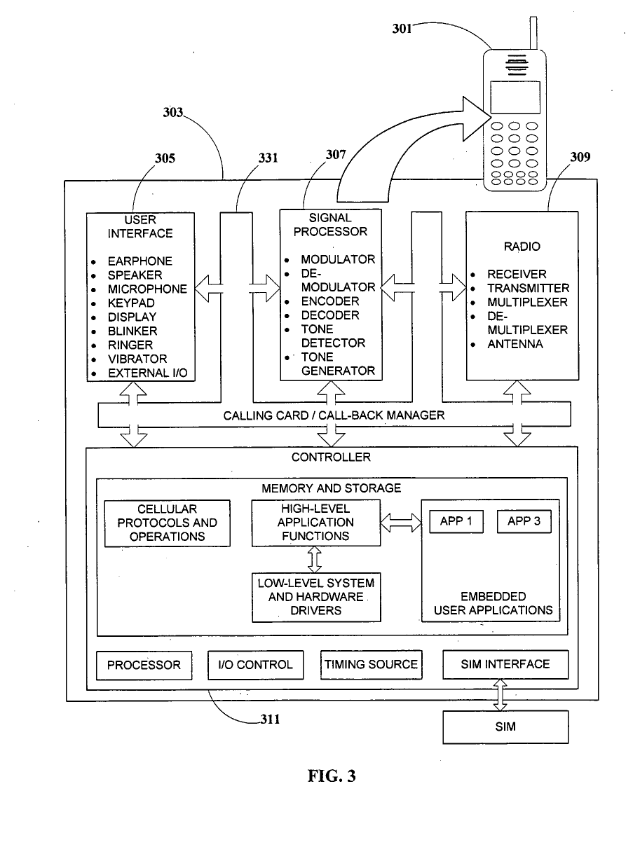

FIG. 3 illustrates a mobile telephone 301 with a functional block 303 contains a user interface 305, a signal processor 307, a radio 309, and a controller 311.

In a first embodiment of the present invention, a call manager 331 for handling calling card and call-back calls has an interface between controller 311 and user interface 305, signal processor 307, and radio 309. This configuration is useful with certain operating systems, such as the Windows Mobile operating system and the Windows CE operating system. The configuration of this embodiment is also useful in non-smart cellular telephones with the use of the SIM toolkit and Java SIM's.

### Call Manager Between High-Level Application Functions and Low-Level System and Hardware Drivers

FIG. 4 illustrates a mobile telephone 401 with a functional block 403, and a controller 411 having a memory and storage unit 413. Within memory and storage unit 413 are high-level application functions 417 and low-level system and hardware drivers 419. There are also embedded user applications 421 within which is located a call manager 423, which includes an interface 425 between high-level application functions 417 and low-level hardware drivers 419. In this manner, call manager 423 can monitor the activities of the high-level telephone functions (such as when the user attempts to place a call), and can thereby implement the method described previously and illustrated in FIG. 2.

The configuration illustrated in FIG. 4 and described above can be employed in mobile telephones which utilize the Symbian operating system.

Furthermore, the method illustrated in FIG. 2 and discussed previously is applicable to mobile telephones which support higher-level commands, including, but not limited to the AT command set, as noted herein.

### Encapsulation in SIM

It will be understood that a method of the present invention may be performed by a suitably-programmed device. Thus, the present invention contemplates a program of device instructions that is readable by a device for executing a method of the invention, or any part thereof. The term “device program” herein denotes any collection of machine-readable codes, and/or instructions, and/or data residing in a machine-readable memory or in machine-readable storage, and executable by a machine for performing a method of the invention or any part thereof.

In particular, an embodiment of the present invention, as illustrated in FIG. 2 and discussed previously, may be performed by a programmed device executing a series of instructions contained in a SIM or other device.

While the invention has been described with respect to a limited number of embodiments, it will be appreciated that many variations, modifications and other applications of the invention may be made.

1. A method for placing an outgoing call from a mobile telephone to a destination having a destination telephone number entered on the mobile telephone by a user, the method comprising:
detecting a user attempt to place an outgoing call;
for an attempted outgoing call placement by a user, obtaining the destination telephone number dialed by the user;
determining whether the destination telephone number corresponds to a local outgoing call versus a long-distance outgoing call;
if the destination telephone number corresponds to a local outgoing call, returning to said detecting a user attempt;
if the destination telephone number corresponds to a long-distance outgoing call, aborting the user's attempted outgoing call placement;
determining an alternate routing for the outgoing call;
accessing a service providing said alternate routing;
sending the destination telephone number entered by the user; and
completing the placement of the outgoing call via said alternate routing.

2. The method of claim 1, wherein said accessing a service providing said alternate routing is selected from the group consisting of:
dialing a service access number;
opening a data session via GPRS; and
opening a data session via WiFi.

3. The method of claim 1, further comprising:
monitoring the mobile telephone to detect an attempt by the user to place an outgoing call.

4. The method of claim 2, wherein said service access number is a local number.

5. The method of claim 1, wherein said alternate routing is a plurality of alternate routings, the method further comprising:
determining the best alternate routing of said plurality of alternate routings according to a predetermined criterion.

6. The method of claim 5, wherein said predetermined criterion is rate.

7. The method of claim 6, further comprising:
determining the rate of an alternate routing for the outgoing call.

8. The method of claim 7, wherein the rate of an alternate routing depends on at least one of time of the call, mobile telephone location, and the destination location, the method further comprising at least one of:
determining the time of the call;
determining mobile telephone location;
determining the destination location; and
calculating the rate of an alternate routing.

9. The method of claim 1, wherein said determining an alternate routing for the outgoing call involves using at least one of:
calling card data;
a available calling card data;
conversion table from MCC to country name;
conversion table from prefix to country name;
mobile telephone service providers feature list;
mobile telephone rates;
roaming rates; and
available SIM cards.

10. The method of claim 8, wherein said determining the rate of an alternate routing for the outgoing call involves using at least one of:
calling card data;
available calling card data;
conversion table from MCC to country name;
conversion table from prefix to country name;
mobile telephone service providers feature list;
mobile telephone rates;
roaming rates; and
available SIM cards.

11. The method of claim 1, wherein said alternate routing is via a calling card.

12. The method of claim 11, further comprising at least one of the following:
encrypting calling card data;
purchasing a calling card; and
recharging a calling card.

13. The method of claim 11, wherein a plurality of calling cards are available for said alternate routing, the method further comprising:
determining the best calling card of said plurality of calling cards, according to a predetermined criterion.

14. The method of claim 13, wherein said predetermined criterion is rate.

15. The method of claim 1, wherein said alternate routing is selected from the group consisting of:
call-back;
local number dialing;
Voice Over Internet Protocol;
GPRS; and
UMTS.

16. The method of claim 1, wherein said completing the placement of the outgoing call further comprises at least one of the following:
sending a subscriber ID;
sending a subscriber PIN;
determining the calling patterns of a calling card; and
receiving a call-back.

17. The method of claim 1, wherein the mobile telephone has access to at least one mobile telephone network, and wherein said determining an alternate routing for the outgoing call further comprises:
identifying said at least one mobile telephone network.

18. The method of claim 17, wherein the mobile telephone is roaming, and wherein said at least one mobile telephone network is a plurality of mobile telephone networks, the method further comprising:
identifying the best of said plurality of mobile telephone networks according to a predetermined criterion.

19. The method of claim 18, wherein said predetermined criterion is selected from the group consisting of:
rate; and
terms of service.

20. The method of claim 18, further comprising:
ranking the networks of said plurality of mobile telephone networks according to said predetermined criterion.

21. The method of claim 1, further comprising:
identifying a location of the mobile telephone.

22. The method of claim 21, wherein said location is of a type selected from the group consisting of:
geographical region;
political region;
mobile telephony region; and
geographical coordinate system.

23. The method of claim 1, wherein the mobile telephone includes a SIM, and wherein at least one of said determining an alternate routing for the outgoing call and said accessing a service providing said alternate routing further comprises at least one of the following:
identifying said SIM; and
configuring said SIM.

24. The method of claim 23, wherein the mobile telephone accepts a plurality of SIM's, the method further comprising at least one of the following:
recommending the best SIM of said plurality of SIM's according to a predetermined criterion; and
selecting the best SIM of said plurality of SIM's according to said predetermined criterion.

25. A call manager operative to perform the method of claim 1 for a mobile telephone.

26. The call manager of claim 25 comprising an interface, wherein said interface is between a high-level application function and a low-level driver in the mobile telephone.

27. In a mobile telephone having a radio, a signal processor, a user interface, and a controller, a call manager for placing an outgoing call from the mobile telephone to a destination having a destination telephone number, the call manager comprising an interface between the controller and the user interface, and wherein the call manager is operative to perform the method of claim 1.

28. A device program product comprising a storage medium for storing a device program operative to perform the method of claim 1.

29. The device program product of claim 28, wherein said storage medium is a SIM.

30. A method for placing an outgoing call from a mobile telephone to a destination having a destination telephone number fed to the mobile telephone, the method comprising:
detecting a user attempt to place an outgoing call;
for an attempted outgoing call placement by a user, obtaining the destination telephone number dialed by the user;
determining a category corresponding to the destination telephone number;
if the destination telephone number corresponds to a first category of outgoing calls, placing the call through a default routing;
if the destination telephone number corresponds to a second category of outgoing calls, aborting the user's attempted outgoing call placement;
determining an alternate routing for the outgoing call; and
placing the outgoing call via said alternate routing.

31. The method of claim 30, wherein said default routing is direct-dial.

32. The method of claim 30, wherein said category is selected from the group consisting of:
direct-dial;
a local;
long-distance;
international long-distance; and
data connection.

33. The method of claim 30, wherein said placing the outgoing call via said alternate routing further comprises accessing a service providing said alternate routing.

34. The method of claim 33, wherein said accessing a service providing said alternate routing is selected from the group consisting of:
dialing a service access number;
opening a data session via GPRS; and
opening a data session via WiFi.

35. The method of claim 30, wherein said alternate routing is selected from the group consisting of:
call-back;
local number dialing;
Voice Over Internet Protocol;
GPRS; and
UMTS.
